(19) United States
(12) Patent Application Publication
(10) Pub. No.: US 2004/0186234 A1
(43) Pub. Date: Sep. 23, 2004

(54) Resin composition

(76) Inventors: Masashi Tsukamoto, Kawasaki-shi (JP); Ichiro Sagae, Kawasaki-shi (JP); Tsutomu Arakawa, Kawasaki-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/483,078

(22) PCT Filed: Sep. 12, 2002
(86) PCT No.: PCT/JP02/09361

Related U.S. Application Data
(60) Provisional application No. 60/322,747, filed on Sep. 18, 2001.

(30) Foreign Application Priority Data
Sep. 14, 2001 (JP) 2001-279567

(51) Int. Cl. C08L 33/04; C08L 35/02

(52) U.S. Cl. 525/191; 525/222

(57) ABSTRACT

A resin composition which comprises 50-95 parts by mass of (A) an elastomer with a weight-average molecular weight of at least 300,000 as measured by gel permeation chromatography, 50-5 parts by mass of (B) an ethylene copolymer with a melting point of no higher than 110° C., and (C) a filler at 100-2000 parts by mass based on the total of 100 parts by mass of (A)+(B). The composition has excellent strength and flexibility and allows high density packing of fillers such as magnetic powders.

### CROSS-REFERENCE TO RELATED APPLICATION

This application is an application filed under 35 U.S.C. §111(a) claiming benefit pursuant to 35 U.S.C. §119(e)(1) of the filing date of the Provisional Application 60/322,747 filed Sep. 18, 2001, pursuant to 35 §111(b).

### TECHNICAL FIELD

The present invention relates to a resin composition with satisfactory strength and flexibility, which allows high density packing of fillers such as magnetic powders or inorganic or organic packing agents. More particularly, the invention relates to a resin composition which can be satisfactorily used in industrial materials, construction materials and automobile parts, including rubber magnets, electromagnetic wave interference materials, electromagnetic wave absorbing materials, flame-retarding resin compositions, heat release sheets, sound insulators, vibration dampers, piezoelectric materials, pyroelectric materials, conductive materials and the like, which require high density packing of fillers such as magnetic powders or inorganic packing agents.

### BACKGROUND ART

Currently employed resin compositions, allowing high packing of fillers such as magnetic powders or inorganic packing agents, are used in a variety of fields including rubber magnets, motors, electromagnetic wave interference materials, electromagnetic wave absorbing materials, flame-retarding resins, sound insulators, vibration dampers, conductive materials and the like. The properties of such products are related to the packing density of the filler, and it is known that a higher density of packing generally results in more favorable properties based on the filler, but also reduces the strength, flexibility and workability.

Such compositions usually require a relative degree of flexibility, in which case various synthetic resins and synthetic rubbers are used. There may be mentioned, for example, soft polyvinyl chloride, ethylene-vinyl acetate copolymer, nitrile rubber, styrene-butadiene elastomer, butyl rubber and chlorinated polyethylene.

In recent years, the demand has increased for compositions containing zero or only trace amounts of halogens in order to relieve the burden on the environment while, from the point of recycling, there is a demand for compositions with as little crosslinking as possible (reformable by melt heating).

As described in Japanese Unexamined Patent Publication No. 62-30144 and elsewhere, chlorinated polyethylene is an elastomer with excellent high packability of magnetic powders and inorganic fillers, but because it, like soft polyvinyl chloride, also contains chlorine, it is also associated with problems in terms of a burden on the environment. Synthetic rubbers such as nitrile rubber and butyl rubber not only have insufficient packability, but in most cases they require crosslinking and are therefore problematic in terms of recycling properties.

On the other hand, Japanese Unexamined Patent Publication No. 60-31550 proposes a composition comprising a specific polyethylene with the addition of a filler; the composition, however, exhibits inadequate flexibility and presents problems when bent in use. Japanese Unexamined Patent Publication No. 56-65036 describes a plastic magnetic composition prepared by treating an elastomer and ethylene-vinyl acetate copolymer with an organic peroxide and partially crosslinking it, but the elastomer molecular weight and compositional ratios are not mentioned, while its inferior packability is a disadvantage.

### DISCLOSURE OF THE INVENTION

In light of these circumstances, it is an object of the present invention to provide a resin composition which does not entail the aforementioned problems, that is, which allows high packing of magnetic powders or inorganic fillers, which exhibits excellent flexibility, strength and workability, and which contains virtually no halogens.

As a result of much diligent research, the present inventors have completed the present invention upon finding that the aforementioned object can be achieved by combining a specific elastomer and an ethylene copolymer.

Specifically, the invention provides a resin composition which comprises 50-95 parts by mass of (A) an elastomer with a weight-average molecular weight of at least 300,000 in terms of polystyrene as measured by gel permeation chromatography, 50-5 parts by mass of (B) an ethylene copolymer with a melting point of no higher than 110° C. (where (A)+(B)=100 parts by mass) and (C) a filler at 100-2000 parts by mass based on the total of 100 parts by mass of (A)+(B).

### BEST MODE FOR CARRYING OUT THE INVENTION

The elastomer (A) used for the invention may be selected from among ethylene-propylene copolymers, and terpolymers thereof with 1,4-hexadiene, dicyclopentadiene, 5-ethylidene-2-norbornene or the like, styrene-butadiene copolymer and its hydrogenated modified products, styrene-isoprene copolymer and its hydrogenated modified products, polybutadiene, acrylonitrile-butadiene copolymer and its hydrogenated modified products, polyisoprene, polyisobutylene, isobutylene-isoprene copolymer and its chlorinated or brominated products, polyurethane, polynorbornene, and the like.

Preferred among these are polyisobutylene and isobutylene-isoprene copolymer, which are elastomers with isobutylene as the monomer unit, wherein polyisobutylene is particularly preferred for its excellent high packing property.

The elastomer (A) has a weight-average molecular weight of at least 300,000 in terms of polystyrene as measured by gel permeation chromatography. If the weight-average molecular weight of the elastomer is less than 300,000, the high packing property for magnetic powder or inorganic fillers is impaired. The weight-average molecular weight is preferably at least 500,000 and more preferably at least 1 million. The upper limit for the molecular weight is not particularly restricted. At greater than 3 million, however, the workability for kneading, extrusion, etc. may be impaired.

The ethylene copolymer (B) used for the invention may be an ethylene-a-olefin copolymer, ethylene-vinyl ester copolymer, ethylene-α,β-unsaturated carboxylic acid ester copolymer, ethylene-α,β-unsaturated carboxylic acid copolymer or ethylene-α,β-unsaturated carboxylic acid-unsaturated carboxylic acid ester copolymer, or an amide, imide or ionomer thereof.

More specifically, as ethylene-α-olefin copolymers there may be mentioned copolymers of ethylene with 1-butene, 1-hexene, 1-octene, 4-methyl-1-pentene, and the like.

As ethylene-vinyl ester copolymers there may be mentioned copolymers of ethylene with vinyl acetate, vinyl caproate, vinyl propionate, vinyl caprylate, vinyl laurate and vinyl stearate.

As ethylene-α,β-unsaturated carboxylic acid ester copolymers there may be mentioned ethylene-acrylic acid ester copolymers and ethylene-methacrylic acid ester copolymers, and more specifically, ethylene-methyl acrylate copolymer, ethylene-ethyl acrylate copolymer, ethylene-butyl acrylate copolymer, ethylene-methyl methacrylate copolymer, ethylene-ethyl methacrylate copolymer and ethylene-glycidyl methacrylate copolymer.

As ethylene-α,β-unsaturated carboxylic acid copolymers or ethylene-α,β-unsaturated carboxylic acid-unsaturated carboxylic acid ester copolymers there may be mentioned ethylene-acrylic acid copolymer, ethylene-acrylic acid-acrylic acid ester copolymers, ethylene-maleic anhydride-acrylic acid ester copolymers, and ionomers such as Na or Zn salts of ethylene-acrylic acid.

Preferred as the ethylene copolymer (B) are ethylene-vinyl acetate copolymer, ethylene-acrylic acid ester copolymers and ethylene-methacrylic acid ester copolymers.

The melting point of the ethylene copolymer (B) is 110° C. or below. The melting point is shown by the peak temperature of crystalline melting according to JIS K7121 by differential scanning calorimetry (DSC). The melting point of an ethylene copolymer is known to depend on the amount of ethylene and the monomer which is copolymerized therewith, with an ethylene copolymer melting point of 110° C. or higher resulting in a lower degree of copolymerization and inferior packing property and flexibility. A satisfactory balance of flexibility and heat resistance can be achieved if the melting point of the ethylene copolymer (B) is preferably in the range of 80° C. to 105° C.

There are no particular restrictions on the molecular weight of the ethylene copolymer (B), but the range for the melt flow rate (test temperature: 190° C., load: 21.18 N), which is an indication of the molecular weight, is preferably about 0.1-50 g/10 min. At less than 0.1 g/10 min the workability for kneading and extrusion is impaired, while at greater than 50 g/10 min, the miscibility with the elastomer (A) is reduced and the packing property tends to be poor.

The proportion of the elastomer (A) and ethylene copolymer (B) is 50-95 parts by mass of (A) and 50-5 parts by mass of (B). The total of (A)+(B) must be 100 parts by mass. The packing property is poor if the elastomer (A) is present at less than 50 parts by mass, and the workability for kneading and extrusion is impaired if it is present at greater than 95 parts by mass.

The filler (C) used for the invention is a magnetic powder, an inorganic filler such as a metal or its oxide, hydroxide, silicate, carbonate, sulfate, or carbon or the like or an organic filler, and it is not particularly restricted.

As examples of magnetic powders there may be mentioned Alnico (Al-Ni-Fe alloy), ferrite (MO·xFe₂O₃, x =Ba,Sr, etc.), a rare earth magnetic powder (Sm-Co, Sm-T, Nd-Fe-B alloy, etc.), pure iron, ferrocarbon powder, ferrosilicon powder, permalloy (Ni-Fe alloy), Fe-Co alloy, Al-Fe alloy, Sendust (Al-Si-Fe alloy), carbonyl iron, manganese bismuth magnet, or the like.

As examples of metals and their oxides or hydroxides there may be mentioned zinc, zinc oxide, copper powder, copper oxide, brass, titanium oxide, boron, tungsten, tungsten oxide, molybdenum oxide, antimony oxide, lead, lead oxide, magnesium oxide, magnesium hydroxide, aluminum powder, alumina, aluminum hydroxide, beryllium oxide, basic magnesium carbonate, silica and the like.

As examples of carbonates there may be mentioned calcium carbonate, magnesium carbonate, dawsonite, and the like. As silicates there may be mentioned talc, clay, mica, calcium silicate, diatomaceous earth, glass (fibers, beads, foam beads), montmorillonite, bentonite, and the like. As sulfates there may be mentioned calcium sulfate, calcium sulfite, barium sulfate, ammonium sulfate, and the like. As carbons there may be mentioned carbon black, graphite, carbon fiber, carbon nanotubes, fullerenes, and the like.

In addition, there may be mentioned silicon carbide, boron nitride, zinc borate, potassium titanate, lead zirconate titanate, barium metaborate, calcium borate, sodium borate, molybdenum sulfide, and the like.

As organic fillers there may be mentioned wood flour, arboreous cotton, cellulose, nylon, aramid or ultrahigh molecular weight polyethylene fiber, fine powder and flakes.

The resin composition of the invention may employ a single type of filler (C) or a combination of several types.

The content of the filler (C) will differ depending on the density of the filler, but will generally be 100-2000 parts by mass per 100 parts by mass of the total of the elastomer (A) and ethylene copolymer (B). At less than 100 parts by mass, the function obtained by high packing of the filler is insufficient, while at greater than 2000 parts by mass, the workability is impaired and the flexibility of the resulting composition is insufficient.

The resin composition of the invention may also contain other resins or elastomers in addition to the aforementioned components (A) to (C), for further modification. However, the amount of such addition is preferably no greater than 30 parts by mass to per 100 parts by mass of (A)+(B).

There may also be added various types of additives, for example, antioxidants, photostabilizers, working aids, lubricants, plasticizers, viscous excipients, flame-retardants, pigments and the like, which are commonly employed in the relevant fields. If necessary, crosslinking may be accomplished using a crosslinking agent such as an organic peroxide, or triallyl cyanurate, triallyl isocyanurate, diallyl phthalate or the like as a crosslinking accelerator.

The method of adding and mixing each of the components and other additives according to the invention may be any method commonly applied for resin or rubber kneading, which employs an open roll, Banbury mixer, pressurized kneader, intermixer, extruder, etc.

The resin composition of the invention may be shaped using any desired method such as die-based compression molding, injection molding, transfer molding or extrusion molding, or calender molding.

The present invention will now be explained in further detail by way of examples and comparative examples, with the understanding that these examples in no way limit the invention.

In the examples and comparative examples, the compounds are referred to as follows.

Ethylene-propylene-dien terpolymer: EPDM

Isobutylene-isoprene copolymer: IIR

Polyisobutylene: PBR

Ethylene-vinyl acetate copolymer: EVA

Ethylene-methyl acrylate copolymer: EMA

Ethylene-ethyl acrylate copolymer: EEA

Ethylene-methyl methacrylate copolymer: EMMA

Ethylene-1-butene copolymer: VLDPA

Low-density polyethylene: LDPE

Ethylene-1-butene copolymer: LLDPE Measurement of elastomer weight-average molecular weight (Mw)

This was measured by gel permeation chromatography (GPC).

Eluent: THF (1 mL/min)

Molecular weight standard substance: polystyrene

Detector: RI

Column: Shodex KF803L+KF804L+KF805L Measurement of ethylene copolymer melting point

This was measured by differential scanning calorimetry (DSC) according to JIS K7121, taking the peak temperature of crystalline melting as the melting point. The temperature elevating rate was 10° C./min.

Measuring apparatus: Model DSC-7 by Perkin-Elmer Co. Elastomers

EPDM1:

Ethylene-propylene-(5-ethylidene-2-norbornene) terpolymer (EP57C, product of JSR Co., Ltd.), having a weight-average molecular weight (hereinafter, Mw) of 500,000 as measured by GPC, a propylene content of 28% and an iodine value of 15.

EPDM2:

Ethylene-propylene-(5-ethylidene-2-norbornene) terpolymer (EP51, product of JSR Co., Ltd.), having an Mw of 200,000, a propylene content of 26% and an iodine value of 20.

IIR1:

Isobutylene-isoprene copolymer (Butyl 268, product of JSR Co., Ltd.), having an Mw of 450,000 and an isoprene content of 1.5%.

IIR2:

Isobutylene-isoprene copolymer (Butyl 065, product of JSR Co., Ltd.), having an Mw of 250,000 and an isoprene content of 1.0%.

PBR1:

Polyisobutylene (Vistanex MML-140, Product of Exxon Chemical Japan, Ltd.), having an Mw of 2 million.

PBR2:

Polyisobutylene (Vistanex MML-80, Product of Exxon Chemical Japan Ltd.), having an Mw of 800,000. Ethylene (co)polymers

EVA:

Ethylene-vinyl acetate copolymer (JREX EVA VE430A, product of Japan Polyolefin Co., Ltd.) having a vinyl acetate content of 14 wt %, a melting point of 92° C. and a melt flow rate (hereinafter, MFR) of 2 g/10 min as measured with a test temperature of 190° C. and a load of 21.18 N.

EMA1:

Ethylene-methyl acrylate copolymer (Reskupal RB5200, product of Japan Polyolefin Co., Ltd.) having a methyl acrylate content of 20 wt %, a melting point of 77° C. and an MFR of 8 g/10 min.

EMA2:

Ethylene-methyl acrylate copolymer (Reskupal RB5120, product of Japan Polyolefin Co., Ltd.) having a methyl acrylate content of 12 wt %, a melting point of 90° C. and an MFR of 8 g/10 min.

EEA1:

Ethylene-ethyl acrylate copolymer (JREX EEA A4250, product of Japan Polyolefin Co., Ltd.) having an ethyl acrylate content of 25 wt %, a melting point of 91° C. and an MFR of 5 g/10 min.

EEA2:

Ethylene-ethyl acrylate copolymer (JREX EEA A1150, product of Japan Polyolefin Co., Ltd.) having an ethyl acrylate content of 15 wt %, a melting point of 99° C. and an MFR of 1 g/10 min.

EMMA:

Ethylene-methyl methacrylate copolymer (Acryft WM403, product of Sumitomo Chemical) having a methyl methacrylate content of 38 wt %, a melting point of 57° C. and an MFR of 15 g/10 min.

VLDPE:

Ethylene-l-butene copolymer (Excelen VL EUL130, product of Sumitomo Chemical) having a density of 0.898 g/cm³, a melting point of 108° C. and an MFR of 1 g/10 min.

LDPE:

Low-density polyethylene (JREX LD JK401N, product of Japan Polyolefin Co., Ltd.) having a density of 0.918 g/cm³, a melting point of 108° C. and an MFR of 2 g/10 min.

LLDPE:

Ethylene-1-hexene copolymer (linear low-density polyethylene) (Harmorex NF324A, product of Japan Polyolefin Co., Ltd.) having a density of 0.905 g/cm³, a melting point of 120° C. and an MFR of 1 g/10 min. Filler

The filler used was strontium ferrite (hereinafter referred to as “ferrite”. Product of Toda Kogyo Corp.) with a mean particle size of 1 μm. Additional component

As a thermal stabilizer there was used n-octadecyl-3-(4′-hydroxy-3′, 5′-di-t-butylphenyl) propionate (hereinafter referred to as “AO agent”. Product of Asahi Denka Co., Ltd.).

Examples 1-13 and Comparative Examples 1-5

Table 1 shows the compositions of the examples and comparative examples in terms of parts by weight. Kneading was accomplished by masticating the elastomer with a 6-inch roll at 130° C., followed by addition of the ethylene copolymer and 5 minutes of kneading. The ferrite and AO agent were added and then, after kneading for 10 minutes, it was made into a sheet with a thickness of about 2 μm.

The evaluation was conducted as follows, after punching the obtained sheet. Hardness test

This was conducted according to JIS-K6253 to determine the D durometer hardness. Tensile test

This was conducted according to JIS-K6251. However, the tensile test piece shape was a No.2 dumbbell, the dumbbell punching was conducted in the grain direction, and the test speed was 200 mm/min. Bending test

A short test strip with a width of 3 mm and a length of 40 mm in the grain direction was punched out from the sheet and bent 1800° at 23° C., and the presence of any cracking was noted.

∘: No cracking

x: Cracking

The evaluation results are shown in Table 1. The footnote “unsheetable” indicates that that a sheet could not be formed with the roll, and the packing property was notably inferior.

TABLE 1

| | | | Example | | | | | | | | | | | | |
|---|---|---|---|---|---|---|---|---|---|---|---|---|---|---|---|
| | | | 1 | 2 | 3 | 4 | 5 | 6 | 7 | 8 | 9 | 10 | 11 | 12 | 13 |
| Composition | Elastomer | EPDM 1 | 70 | | | | | | | | | | | | |
| in | | EPDM 2 | | | | | | | | | | | | | |
| parts | | IIR 1 | | 70 | | | | | | | | | | | |
| by | | IIR 2 | | | | | | | | | | | | | |
| mass | | PBR 1 | | | 70 | | 70 | 70 | 70 | 70 | 70 | 70 | 60 | 80 | 90 |
| | | PBR 2 | | | | 70 | | | | | | | | | |
| | Ethylene | EVA | | | | | 30 | | | | | | | | |
| | copolymer | EMA 1 | | | | | | 30 | | | | | | | |
| | | EMA 2 | | | | | | | 30 | | | | | | |
| | | EEA 1 | 30 | 30 | 30 | 30 | | | | | | | 40 | 20 | 10 |
| | | EEA 2 | | | | | | | | 30 | | | | | |
| | | EMMA | | | | | | | | | 30 | | | | |
| | | VLDPE | | | | | | | | | | 30 | | | |
| | | LDPE | | | | | | | | | | | | | |
| | | LLDPE | | | | | | | | | | | | | |

| | | | | | | | | | | | | | | |
|---|---|---|---|---|---|---|---|---|---|---|---|---|---|---|
| | Ferrite | 900 | 900 | 900 | 900 | 900 | 900 | 900 | 900 | 900 | 900 | 900 | 900 | 900 |
| | AO agent | 1 | 1 | 1 | 1 | 1 | 1 | 1 | 1 | 1 | 1 | 1 | 1 | 1 |
| Properties | Hardness (HDD) | 56 | 53 | 54 | 54 | 56 | 55 | 57 | 55 | 54 | 56 | 57 | 53 | 49 |
| | Tensile strength | 4.8 | 4.5 | 6.0 | 6.6 | 6.0 | 6.4 | 6.0 | 6.5 | 5.0 | 4.8 | 5.8 | 5.2 | 4.7 |
| | (MPa) | | | | | | | | | | | | | |
| | Elongation (%) | 70 | 90 | 200 | 110 | 140 | 90 | 80 | 170 | 210 | 60 | 90 | 300 | 360 |
| | Bendability | ∘ | ∘ | ∘ | ∘ | ∘ | ∘ | ∘ | ∘ | ∘ | ∘ | ∘ | ∘ | ∘ |

| | | | Comparative Example | | | | |
|---|---|---|---|---|---|---|---|
| | | | 1 | 2 | 3 | 4 | 5 |
| Composition | Elastomer | EPDM 1 | | | | | |
| in | | EPDM 2 | 70 | | | | |
| parts | | IIR 1 | | | | | |
| by | | IIR 2 | | 70 | | | |
| mass | | PBR 1 | | | 70 | 40 | 97 |
| | | PBR 2 | | | | | |
| | Ethylene | EVA | | | | | |
| | copolymer | EMA 1 | | | | | |
| | | EMA 2 | | | | | |
| | | EEA 1 | 30 | 30 | | 60 | 3 |
| | | EEA 2 | | | | | |
| | | EMMA | | | | | |
| | | VLDPE | | | | | |
| | | LDPE | | | | | |
| | | LLDPE | | | 30 | | |

| | | | | | | |
|---|---|---|---|---|---|---|
| | Ferrite | 900 | 900 | 900 | 900 | 900 |
| | AO agent | 1 | 1 | 1 | 1 | 1 |
| Properties | Hardness (HDD) | * | 52 | * | 60 | * |
| | Tensile strength | | 3.8 | | 6.8 | |
| | (MPa) | | | | | |
| | Elongation (%) | | 40 | | 30 | |
| | Bendability | | x | | x | |

* = Unsheetable

Industrial Applicability

According to the present invention it is possible to provide a resin composition with satisfactory strength and flexibility, which also allows high density packing of fillers such as magnetic powders or inorganic packing agents. It may be satisfactorily used in industrial materials, construction materials, automobile parts and the like, including rubber magnets, electromagnetic wave interference materials, electromagnetic wave absorbing materials, flame-retarding resin compositions, heat release sheets, sound insulators, vibration dampers, piezoelectric materials, pyroelectric materials, conductive materials, etc., which require high density packing of fillers such as magnetic powders or inorganic packing agents.

1. A resin composition comprising 50-95 parts by mass of (A) an elastomer with a weight-average molecular weight of at least 300,000 in terms of polystyrene as measured by gel permeation chromatography, 50-5 parts by mass of (B) an ethylene copolymer with a melting point of no higher than 110° C. (where (A)+(B)=100 parts by mass) and (C) a filler at 100-2000 parts by mass based on the total of 100 parts by mass of (A)+(B).

2. A resin composition according to claim 1, wherein the elastomer (A) is an elastomer with isobutylene as a monomer unit.

3. A resin composition according to claim 2, wherein the elastomer (A) is polyisobutylene.

4. A resin composition according to claim 3, wherein the weight-average molecular weight of the polyisobutylene in terms of polystyrene is at least 1 million.

5. A resin composition according to claim 1, wherein the ethylene copolymer (B) is at least one selected from the group consisting of ethylene-vinyl ester copolymer, ethylene-acrylic acid ester copolymer and ethylene-methacrylic acid ester copolymer.

6. A resin composition according to claim 5, wherein the ethylene copolymer (B) is at least one selected from the group consisting of ethylene-vinyl acetate copolymer, ethylene-methyl acrylate copolymer, ethylene-ethyl acrylate copolymer and ethylene-methyl methacrylate copolymer.

7. A resin composition according to claim 5 or 6, wherein the melting point of the ethylene copolymer (B) is between 80° C. and 105° C.

8. A resin composition according to claim 1, wherein the filler (C) is a magnetic powder.
